(19) United States
(12) Patent Application Publication
(10) Pub. No.: US 2026/0178161 A1
(43) Pub. Date: Jun. 25, 2026

(54) FACILITATING COMMUNICATION AMONG AVATARS IN A VIRTUAL ENVIRONMENT

(71) Applicant: International Business Machines Corporation, Armonk, NY (US)

(72) Inventors: Jun Feng DUAN, Beijing (CN); Su LIU, Austin, TX (US); Peng Hui JIANG, Beijing (CN); Guang Han SUI, Beijing (CN); Jun SU, Beijing (CN); Yu ZHU, Beijing (CN)

(21) Appl. No.: 18/991,310

(22) Filed: Dec. 20, 2024

(51) Int. Cl. G06F 3/04815; G06F 3/01; G06T 13/40

(52) U.S. Cl. CPC G06F 3/04815; G06F 3/013; G06T 13/40

(57) ABSTRACT

In some implementations, a metaverse platform determines an attention direction associated with an avatar in a virtual space having two or more groups of additional avatars rendered therein. Each of two or more conversations may be associated with a respective group of the two or more groups. The metaverse platform may determine, based on the attention direction, an interest prediction indicative of a predicted group of interest of the two or more groups. The metaverse platform may provide, based on the interest prediction and to a client associated with the avatar, experience enhancement data to cause an output device associated with the client to output an experience enhancement corresponding to a conversation associated with the predicted group of interest.

### BACKGROUND

The present disclosure relates to communication in a metaverse, and for example, relates to facilitating communication among avatars in a metaverse environment.

A metaverse environment (also referred to as a virtual space, virtual universe, virtual world, or virtual environment) is a computer-simulated environment which may be populated by many users who can create a personal avatar, and simultaneously and independently explore the virtual world, participate in its activities, and communicate with others. It is a concept that merges virtual reality (VR), augmented reality (AR), and other immersive technologies to create a digital environment where users can communicate, collaborate, and engage with each other and digital objects. Virtual worlds are closely related to mirror worlds. In a virtual world, the user accesses a computer-simulated world which presents perceptual stimuli to the user, who in turn can manipulate elements of the modelled world and thus experience a degree of presence

### SUMMARY

According to an aspect of the present disclosure, a computer system is provided. The computer system includes a processor set, one or more computer-readable storage media, and program instructions stored on the one or more computer-readable storage media. The program instructions cause the processor set to perform operations. These operations include determining an attention direction associated with an avatar in a virtual space. The virtual space has two or more groups of additional avatars rendered therein. Each of two or more conversations is associated with a respective group of the two or more groups. The operations also include determining an interest prediction based on the attention direction. The interest prediction is indicative of a predicted group of interest of the two or more groups. The operations further include providing experience enhancement data based on the interest prediction and to a client associated with the avatar. The experience enhancement data causes an output device associated with the client to output an experience enhancement corresponding to a conversation associated with the predicted group of interest.

According to another aspect of the present disclosure, a method is provided. The method includes determining an attention direction associated with an avatar in a virtual space. The virtual space has two or more groups of additional avatars rendered therein. Each of two or more conversations is associated with a respective group of the two or more groups. The method also includes determining an interest prediction based on the attention direction. The interest prediction is indicative of a predicted conversation of interest of the two or more conversations. The method further includes providing experience enhancement data based on the interest prediction and to a client associated with the avatar. The experience enhancement data causes an output device associated with the client to output an experience enhancement corresponding to the predicted conversation of interest.

According to a further aspect of the present disclosure, a computer program product is provided. The computer program product includes one or more computer-readable storage media and program instructions stored on the one or more computer-readable storage media. The program instructions perform operations. These operations include determining an attention direction associated with an avatar in a virtual space. The virtual space has two or more groups of additional avatars rendered therein. The operations also include determining an interest prediction based on the attention direction. The interest prediction is indicative of a predicted group of interest of the two or more groups of additional avatars. The operations further include providing experience enhancement data based on the interest prediction and to a client associated with the avatar. The experience enhancement data causes an output device associated with the client to output an experience enhancement corresponding to the predicted group of interest.

### BRIEF DESCRIPTION OF THE DRAWINGS

FIG. 1 is a diagram of an example system described herein.

FIGS. 2A and 2B are diagrams of an example implementation of a system for facilitating communication among avatars in a metaverse environment described herein.

FIG. 3 is a diagram of an example computing environment in which systems and/or methods described herein may be implemented.

FIG. 4 is a diagram of example components of one or more devices of FIG. 1.

FIG. 5 is a flowchart of an example process associated with facilitating communication among avatars in a metaverse environment.

### DETAILED DESCRIPTION

The following detailed description of example implementations refers to the accompanying drawings. The same reference numbers in different drawings may identify the same or similar elements.

Although there is no universally accepted definition of the “metaverse,” many see it as an iteration of the internet that provides virtual spaces in which users can interact in persistent, shared, virtual spaces linked into a perceived virtual universe or virtual world. Virtual spaces such as these can provide a variety of experiential scenarios used in education, training, entertainment, socializing, and/or conducting business, among other examples. In a virtual space, a user may control movements of an avatar (e.g., a two-dimensional (2D) or 3D graphical representation of the user) in order to interact with the environment. For example, the virtual avatar can be controlled based on user input.

The term avatar refers to a user's representation of himself or herself, whether in the form of a 3D model used in computer games, a 2D icon (picture) used on Internet forums and other communities, or a text construct found on early multi-player computer games. An avatar in a virtual space essentially provides the representation of a user's character's appearance in the virtual space on a video screen. In some cases, the user's representation may be fixed. In other cases, a user's representation may be dynamic and/or otherwise configurable. For example, a metaverse application (e.g., a computer application that generates and manages one or more virtual spaces) may provide for a user's avatar to be dressed in a wide range of clothing, given tattoos and haircuts, and may be able to body build or become obese depending upon user actions. Avatars in virtual environments can provide for a virtual experience that is similar to real-life face-to-face communication, such as through facial expressions and body language cues.

As used herein, the term “virtual space” as used herein can refer to a computer-generated environment or other intangible space. Furthermore, the term “metaverse” as used herein can refer to a collection of online virtual spaces which are accessible to one or more players of one or more online games, workspaces, social groups, and/or communities, among other examples. The terms “virtual space,” “virtual environment,” “game environment” and the like as used herein can refer to a region, sub-region, or area of a metaverse such as a country, city, era, building, etc., which is in some way recognizably different from another region, sub-region, or area provided in the metaverse. A region, sub-region, or area of a metaverse may be, be similar to, include, or be included in one or more virtual spaces. In some implementations, certain areas provided in a metaverse may be restricted to some users.

In some implementations, a user may register an account with a metaverse platform and then create and/or control characters that can interact with the virtual world and with other characters created by other users in the virtual world provided by the metaverse platform. The term “character” as used herein can refer to a persona created by a user in a metaverse, while the term “avatar” as used herein can refer to the appearance or representation (for example, physical embodiment) and/or other characteristics of a character in the metaverse. An avatar may be a humanoid or a wide variety of other form in appearance, have a wide range of physical attributes, and/or be clothed or otherwise customized.

In the rapidly evolving landscape of metaverse environments, users are increasingly confronted with the challenge of navigating complex virtual social spaces populated by numerous avatars engaged in simultaneous conversations. These digital realms, designed to mimic real-world social interactions, often overwhelm users with an abundance of information and stimuli. The sheer volume of concurrent discussions and activities can lead to cognitive overload, making it difficult for users to identify and engage in conversations that align with their interests or objectives. This challenge is particularly pronounced in scenarios such as virtual conferences, social gatherings, or networking events, where the potential for meaningful interactions is high, but the means to efficiently discover and join relevant conversations are limited.

Current metaverse platforms typically employ one of two extremes in managing group conversations: either implementing strict privacy controls that completely isolate group discussions, or allowing unrestricted access to all conversations within a virtual space. The former approach, while preserving privacy, significantly hinders the discovery of potentially interesting or relevant discussions. Conversely, the latter approach often results in information overload, as users are inundated with snippets of numerous conversations without context or relevance filters. This dichotomy presents a significant challenge in balancing the need for open communication with the desire for focused, meaningful interactions in virtual environments.

Furthermore, the diverse nature of metaverse users, spanning different languages, and backgrounds, introduces additional complexities in facilitating effective communication. Users may struggle to identify conversations of interest due to language barriers or regional nuances, potentially missing valuable opportunities for cross-regional exchange and learning. The absence of intelligent, context-aware systems to bridge these gaps and facilitate relevant interactions poses a substantial obstacle to realizing the full potential of metaverse environments as platforms for global communication and collaboration.

Implementations described herein are directed to a method and system for facilitating communication among avatars in a metaverse environment. Some implementations selectively share parts of conversations between groups of avatars based on determined interest and relevance. A metaverse platform may determine an attention direction of an avatar. An attention direction refers to a direction, in relation to a coordinate system within a virtual space, in which the attention of the avatar or the user thereof is directed (or appears to be directed). An attention direction may be determined based on a gaze direction of an avatar, a direction of movement of the avatar, and/or any other attribute associated with an avatar that may be indicative of a direction of the attention of the avatar or the user thereof. A gaze direction of an avatar is a direction in which the eyes (or “eyesight”) of the avatar are directed (e.g., a field of view of the avatar, a line of sight of the avatar, or a direction of perception input).

The metaverse platform may determine, based on the attention direction, an interest prediction. The interest prediction may be a predicted interest, of the avatar or the user thereof, in a group of other avatars (referred to herein as a “predicted group”), a conversation associated with a group of other avatars (referred to herein as a “predicted conversation”), and/or an avatar of a group of other avatars (referred to herein as a “predicted avatar”). In some implementations, if an attention direction of the avatar is directed to a particular group for a predefined period of time, or if the avatar is moving towards the group, the metaverse platform may determine the group to be a predicted group. In some implementations, based on identifying a predicted group, a predicted conversation, and/or a predicted avatar, the metaverse platform may determine a level of interest of the avatar (or the user thereof) based on the content of the conversation and a profile associated with the avatar.

The metaverse platform may provide an experience enhancement based on the interest prediction. The experience enhancement may include providing a summary of a predicted conversation, a keyword of a predicted conversation, and/or any other information about a predicted group, a predicted conversation, or a predicted avatar. For example, in some implementations, the metaverse platform may obtain profile data associated with a profile that is associated with the avatar. The profile associated with the avatar may include a user profile (e.g., a profile associated with a user of the avatar) or an avatar profile (e.g., a profile specific to the avatar, which may be different, for example, from another profile associated with another avatar associated with the user). The profile may include profile data indicative of any number of factors such as event history, regional background, demographics, interests, and/or recent activities, among other examples.

Implementations described herein are directed to determining if the level of interest exceeds a threshold. If the threshold is exceeded, the metaverse platform shares a summary or key aspects of the group's conversation with the avatar. This sharing process is designed to be progressive, revealing more details as the avatar shows increased interest. For example, initially, only keywords or a brief summary might be displayed. As the avatar moves closer or maintains focus for a longer period, more comprehensive summaries or even snippets of the actual conversation may be revealed. The metaverse platform may use a scoring mechanism to quantify the level of interest, considering factors such as the avatar's proximity to the group, duration of focus, content relevance to the avatar's profile, and the presence of known contacts within the group.

Implementations described herein are directed to providing translations, regional context, or interpretations of gestures to improve communication across language and regional barriers. The metaverse platform can provide real-time translations of conversations, allowing avatars to engage with groups speaking different languages. Additionally, the metaverse platform can interpret and explain regional gestures or references, further breaking down communication barriers in diverse metaverse settings. The metaverse platform may also incorporate a two-way notification system, not only informing the approaching avatar about potentially interesting conversations but also notifying the group about an interested avatar nearby. This feature could display a brief profile of the approaching avatar to the group, facilitating easier introductions and encouraging more inclusive conversations.

In some implementations, the metaverse platform selectively shares parts of conversations between groups of avatars based on determined interest and relevance. Accordingly, an advantage of the selective sharing of conversations is reduced information overload for users in crowded metaverse environments. Additionally, an advantage of the selective sharing of conversations is increased efficiency in finding relevant and interesting discussions, allowing users to more quickly engage in meaningful interactions.

In some implementations, the metaverse platform analyzes an avatar's profile, including factors such as event history, demographics, interests, and recent activities, to determine relevance of conversations. Accordingly, an advantage of the profile analysis is highly personalized content delivery tailored to each individual user's preferences and context. Additionally, an advantage of the profile analysis is improved discovery of like-minded individuals and groups with shared interests, facilitating community building within the metaverse.

In some implementations, the metaverse platform provides real-time translations, regional context, or interpretations of gestures to improve communication across languages. Accordingly, an advantage of the translation and regional interpretation features is enhanced cross-regional communication and understanding in diverse metaverse environments. Additionally, an advantage of the translation and regional interpretation features is reduced potential for misunderstandings or unintentional offense due to regional differences, promoting more inclusive and harmonious interactions.

In some implementations, a machine learning (ML) component may be used to determine an attention direction, determine an interest prediction, generate and/or analyze profile data, and/or generate experience enhancement data, among other examples. A machine learning (ML) component refers to software capable of performing ML. ML is a subset of artificial intelligence (AI) that involves the development of algorithms and statistical models enabling computers to perform tasks without explicit programming. ML leverages large datasets to identify patterns, make decisions, and improve over time based on experience. ML focuses on creating systems that can learn from data, adapt to new inputs, and generate predictions or actions.

For example, an ML component may be or include one or more ML models, ML algorithms, and/or ML systems including combinations of ML algorithms and ML models. An ML component may be implemented on any number of different hardware devices and may include one or more machine learning models. ML is a field of study that gives computers the ability to perform certain tasks without being explicitly programmed to perform those tasks. In traditional computing, a programmer would encode instructions (e.g., to solve a quadratic equation using the quadratic formula), and the computer would perform those exact instructions. In contrast, in ML, a computer can be provided with examples and be trained to perform a task such as prediction or classification, without the programmer encoding explicit instructions for the task. ML explores the study and construction of algorithms, also referred to herein as tools, models, and/or components, which may learn from existing data and make predictions about new data. Such ML tools operate by building a model from example training data in order to make data-driven predictions or decisions expressed as outputs or assessments. In some example embodiments, different ML models may be used. ML models may include, for example, K-means clustering models, linear regression models, Logistic Regression (LR) models, Naive-Bayes models, Random Forest (RF) regression models, gradient boost models, neural networks (NN), matrix factorization models, and/or Support Vector Machines (SVMs). Machine learning models may be implemented for use in a variety of use cases (e.g., language processing, image feature extraction, cyberthreat detection, or recommendation production), using a variety of approaches (e.g., supervised learning, unsupervised learning, or reinforcement learning), and in a variety of structures (e.g., a neural network, decision tree, linear regression, vector machine, Bayesian network, genetic algorithm, or deep learning system).

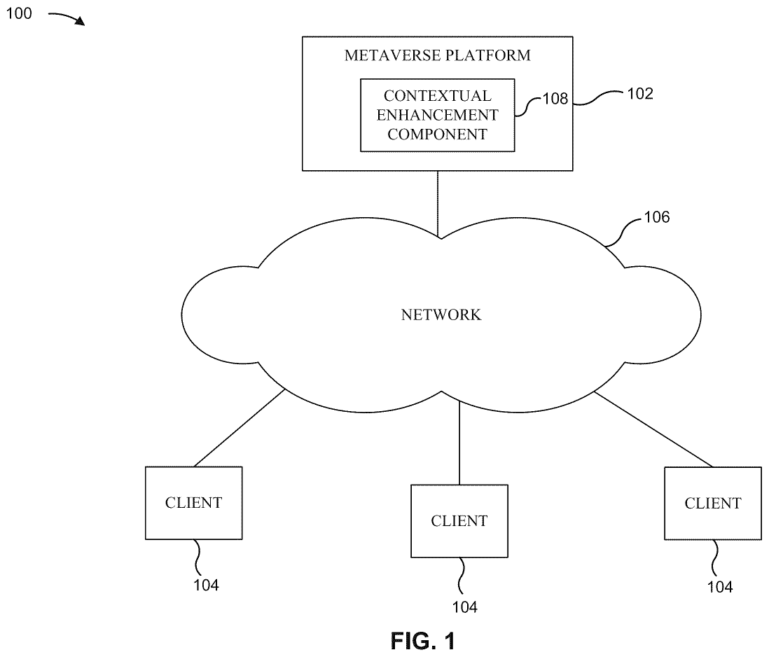

FIG. 1 is a diagram of an example computer system 100 described herein. As shown in FIG. 1, the computer system 100 may include a metaverse platform 102, clients 104, and a network 106. The computer system 100 may interface a system user and one or more metaverse servers according to interface operations of the client 104. Although the depicted computer system 100 is shown and described herein with certain components and functionality, other embodiments of the computer system 100 may be implemented with fewer or more components or with less or more functionality.

The metaverse platform 102 hosts a simulated virtual world, or a metaverse, for a plurality of clients 104. In some implementations, the metaverse platform 102 may be, be similar to, include, or be included in one or more metaverse servers. In some implementations, a specified area (e.g., a visual space, a portion of a visual space, or a group of visual spaces) of the metaverse may be simulated by a single server instance, and multiple server instances may be run on a single metaverse server included in the metaverse platform 102. In some embodiments, the metaverse platform 102 may include a plurality of simulation servers dedicated to physics simulation in order to manage interactions and handle collisions between characters and objects in a metaverse. The metaverse platform 102 also may include a plurality of storage servers, apart from the plurality of simulation servers, dedicated to storing data related to objects and characters in the metaverse world. The data stored on the plurality of storage servers may include object shapes, avatar shapes and appearances, audio clips, metaverse related scripts, and other metaverse related objects.

As shown, the metaverse platform 102 also may include a contextual enhancement component 108. The contextual enhancement component 108 may be, be similar to, include, or be included in software and/or hardware configured to perform methods and operations described herein for facilitating communication among avatars in a metaverse environment.

A client 104 may include hardware and/or software configured to manage an interface between a system user and the metaverse platform 102. In some implementations, a client 104 may include a client application and/or a client computer. For example, in some implementations, a client 104 may refer to a client application that is implemented on one or more client computers. In some implementations, the client 104 may refer to a client computer on which are implemented one or more client applications. The client 104 may be, be similar to, include, or be included in any type of computing device configured to communicate with the metaverse platform 102 to provide a metaverse experience to a user of the client 104. A metaverse experience may include any type of experience associated with one or more virtual spaces, as described herein. For example, a metaverse may refer to an interactive experience provided to a user via audio outputs and inputs, video outputs and inputs, tactile outputs and inputs, and/or any other type of outputs and inputs that may enable a user to experience one or more aspects of a virtual space.

In some implementations, a client 104 may be, be similar to, include, or be included in a desktop computer, a laptop computer, a mobile computing device, or an extended reality (XR) device such as, for example, a virtual reality (VR) device, an augmented reality (AR) device, and/or a mixed reality (MR) device.

The network 106 may be, be similar to, include, or be included in one or more wired networks, one or more wireless networks, or a combination thereof. For example, the network 106 may represent include a public network (e.g., the internet), a private network (e.g., a local area network (LAN), a wide area network (WAN)), a wired network (e.g., Ethernet network), a wireless network (e.g., an 802.11 network, a Wi-Fi network, or wireless LAN (WLAN)), a cellular network (e.g., a Long Term Evolution (LTE) network), routers, hubs, switches, server computers, and/or a combination thereof.

As indicated above, FIG. 1 is provided as an example. Other examples may differ from what is described with regard to FIG. 1. As an example, fewer than three or more than three clients 104 may be included in the computer system 100. The number and arrangement of devices shown in FIG. 1 are provided as an example. There may be additional devices (e.g., a large number of devices), fewer devices, different devices, or differently arranged devices than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) shown in FIG. 1 may perform one or more functions described as being performed by another set of devices shown in FIG. 1.

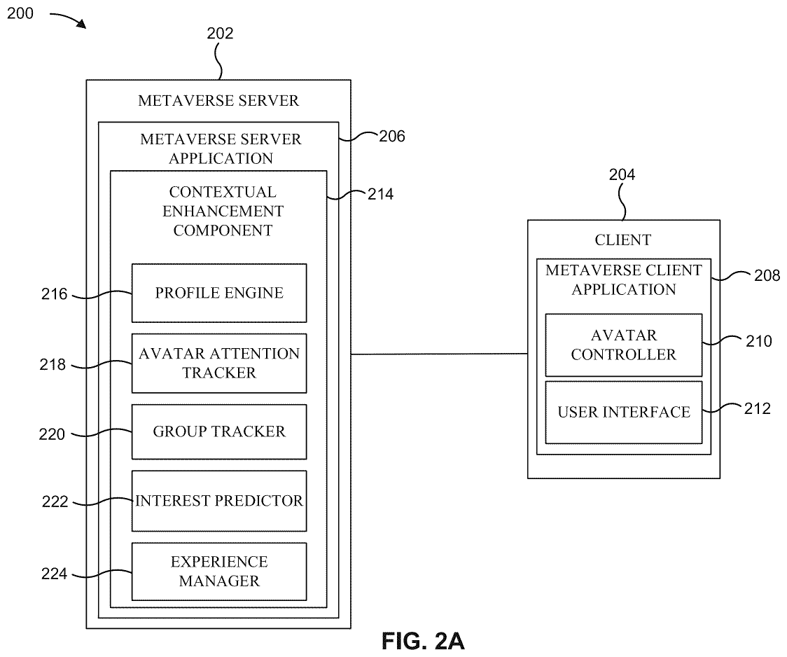

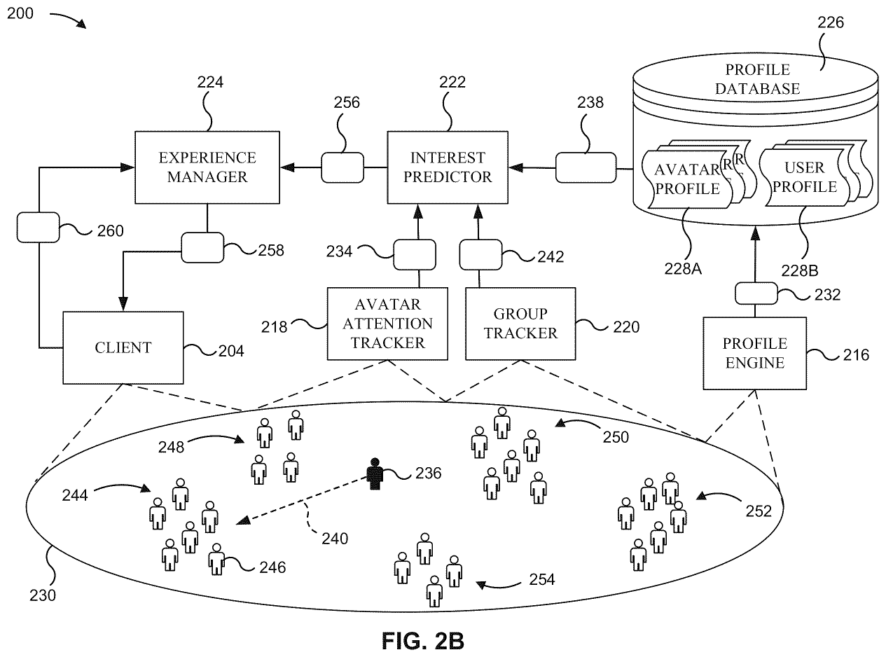

FIGS. 2A and 2B are diagrams of an example implementation 200 described herein. As shown in FIGS. 2A and 2B, the example implementation 200 may be, be similar to, include, or be included in the computer system 100. As shown, the example implementation 200 includes a metaverse server 202 and a client 204. The metaverse server 202 may be, be similar to, include, or be included in, the metaverse platform 102 shown in FIG. 1. The client 204 may be, be similar to, include, or be included in the client 104 shown in FIG. 1.

As shown in FIG. 2A, the metaverse server 202 includes a metaverse server application 206 and a contextual enhancement component 214. The metaverse server application 206 is responsible for hosting and managing the virtual environment of the metaverse. It may handle tasks such as rendering the virtual space, managing avatar interactions, and coordinating communication between clients. The metaverse server application 206 may be implemented using various technologies, such as game engines, 3D rendering libraries, or custom-built software frameworks optimized for large-scale virtual environments.

The contextual enhancement component 214 is configured to address the technical problem of information overload and inefficient communication in crowded metaverse environments. The contextual enhancement component 214 component comprises several modules that work together to analyze user behavior, predict interests, and provide relevant information to enhance the user's experience. The contextual enhancement component 214 includes a profile engine 216, an avatar attention tracker 218, a group tracker 220, an interest predictor 222, and an experience manager 224.

The profile engine 216 may be configured to generate, update, analyze, and/or otherwise manage user and avatar profiles. It may store and process information such as user demographics, interests, past behaviors, and preferences. The profile engine 216 may utilize various data structures and algorithms to efficiently organize and retrieve profile information. For example, it may employ graph databases to represent complex relationships between users, interests, and behaviors, or use ML models to continually update and refine user profiles based on their interactions in the metaverse.

The avatar attention tracker 218 may monitor the attention and movements of avatars within the virtual space. The avatar attention tracker 218 may use techniques such as ray casting to determine the direction of an avatar's gaze, analyze movement patterns to infer interest, or track the orientation of avatar models. The avatar attention tracker 218 can also incorporate more advanced techniques, such as eye-tracking data from VR headsets, to provide more accurate attention information.

The group tracker 220 may be configured to identify and monitor groups of avatars within the virtual space. The group tracker 220 may employ spatial clustering algorithms to group nearby avatars, analyze conversation patterns to identify active discussions, or use social network analysis techniques to identify pre-existing social groups. The group tracker 220 can adapt to different types of virtual environments, from open spaces to structured meeting rooms, adjusting its grouping criteria accordingly.

The interest predictor 222 may combine data from the profile engine 216, avatar attention tracker 218, and group tracker 220 to predict which conversations or groups might be of interest to a particular avatar. The interest predictor 222 may utilize ML models, such as neural networks or decision trees, trained on historical interaction data to make these predictions. The interest predictor 222 may be designed to handle the uncertainty and noise inherent in user behavior data, using techniques like ensemble learning or Bayesian inference to improve prediction accuracy.

The experience manager 224 may be configured to generate and deliver experience enhancements based on the predictions made by the interest predictor 222. The experience manager 224 may generate summaries of conversations, highlight keywords, or create visual cues to guide users towards interesting groups. The experience manager 224 can be customized to suit different types of virtual environments and user preferences, offering options such as text overlays, spatial audio cues, or haptic feedback for VR users.

On the client side, as shown in FIG. 2A, the client 204 includes a metaverse client application 208, which further comprises an avatar controller 210 and a user interface 212. The metaverse client application 208 may be configured to render the virtual environment on the user's device and facilitate user interactions within the metaverse. The metaverse client application 208 may be implemented as a standalone application, a web-based client, or integrated into existing platforms or operating systems.

The avatar controller 210 may allow users to control their avatar's movements and actions within the virtual space. The avatar controller 210 may support various input methods, such as keyboard and mouse controls, touch interfaces for mobile devices, or motion controls for VR systems. The avatar controller 210 can also incorporate more advanced features, such as gesture recognition or voice commands, to provide a more natural and immersive control experience.

The user interface 212 may provide the means for users to interact with the metaverse environment and receive experience enhancements. The user interface 212 may include elements such as heads-up displays, menus, chat windows, or visual indicators for points of interest. The user interface 212 can be customized to suit different devices and user preferences, offering options such as minimalist designs for mobile devices or more detailed interfaces for desktop users.

As illustrated in FIG. 2B, the metaverse server 202 operates to provide a virtual space 230, which represents the 3D environment of the metaverse. This virtual space 230 can be designed to accommodate various scenarios, from open social areas to structured meeting rooms or event spaces. The virtual space 230 provides the context in which avatars interact and where the contextual enhancement features of this disclosure are applied. The metaverse server 202 may render a user avatar 236 within the virtual space 230. The user avatar 236 represents the avatar controlled by the user of the client 204.

Within the virtual space 230, multiple groups 244, 248, 250, 252, and 254 of avatars 246 are shown, each potentially engaged in different conversations or activities. These groups 244, 248, 250, 252, and 254 represent the dynamic social clusters that form and dissolve in metaverse environments, presenting the challenge of identifying relevant interactions for users. Each group 244, 248, 250, 252, and 254 may have its own characteristics, such as topic of discussion, level of privacy, or membership criteria, which the system takes into account when making predictions and providing enhancements.

The profile database 226 stores user profiles 228A and avatar profiles 228B, which are managed by the profile engine 216. These profiles contain a wealth of information that can be used to make more accurate predictions about user interests. User profiles 228A may include demographic information, interests, or behavior patterns across multiple metaverse sessions. Avatar profiles 228B may contain information specific to a user's representation in the metaverse, such as appearance preferences, social connections, or role-playing characteristics.

The profile engine 216 may collect and store a wide range of additional information within user profiles 228A and avatar profiles 228B. For user profiles 228A, this may include professional background, educational history, language proficiency, social affliations, or personal goals or aspirations. Avatar profiles 228B may contain data on the avatar's virtual possessions, achievements, skills, or reputation within different metaverse communities. The profile engine 216 may also track temporal patterns, such as the user's typical login times, duration of metaverse sessions, or frequency of participation in various types of virtual events.

The interest predictor 222 may leverage this rich profile data to make more nuanced and accurate predictions. For example, the interest predictor 222 may consider a user's professional background when predicting interest in business-related discussions, or take into account language proficiency when suggesting multilingual conversations. The interest predictor 222 may also use temporal data to adjust its predictions based on the time of day or the user's current metaverse session duration. By incorporating this diverse range of profile information, the interest predictor 222 may provide more personalized and contextually relevant recommendations, enhancing the user's metaverse experience.

The profile engine 216 may receive any number of different types of information about avatars, groups of avatars, or users and may generate profile input data 232. The profile engine 216 stores the profile input data 232 in the profile database 226. For example, the profile engine 216 may generate user profiles 228A and/or avatar profiles 228B and may store the profile input data 232 in corresponding profiles 228A or 228B. The profile engine 216 may receive information from various sources such as user-provided information, observed behaviors, or data from connected platforms or services. For example, the profile engine 216 may receive information from the group tracker 220, the avatar attention tracker 218, the interest predictor 222, the experience manager 224, and/or the client 204, among other examples. This continual influx of data may allow the metaverse server 202 to keep profiles up-to-date and improve the accuracy of its predictions over time.

The avatar attention tracker 218 provides attention direction data 234 to the interest predictor 222. The attention direction data represents an attention direction (e.g., the current focus) 240 of the user avatar 236, allowing the system to respond to the user's immediate interests and intentions within the virtual space. The avatar attention tracker 218 may determine an attention direction based on determining a gaze direction of the avatar and/or a direction of movement of the avatar, among other examples.

The avatar attention tracker 218 may employ a variety of techniques to determine an attention direction of an avatar in the virtual space. In some implementations, the avatar attention tracker 218 may analyze the avatar's head orientation and eye movement within the virtual environment. This may involve using advanced rendering techniques to track the avatar's virtual eyes and calculate the intersection of their gaze with objects or other avatars in the scene. The avatar attention tracker 218 may also consider the avatar's body posture and orientation, as users often turn their entire avatar to face objects or groups of interest.

In some cases, the avatar attention tracker 218 may incorporate data from external devices to enhance its accuracy. For example, if the user is wearing a VR headset with built-in eye-tracking capabilities, the avatar attention tracker 218 may receive and process this real-time eye movement data to precisely determine the user's focus within the virtual space. Additionally, the avatar attention tracker 218 may analyze the user's interaction patterns, such as frequent glances towards specific areas or lingering views on particular objects or avatars, to infer sustained attention or interest over time. This multi-faceted approach may allow the avatar attention tracker 218 to provide a comprehensive understanding of the user's attention direction, enabling more accurate and context-aware enhancements to the metaverse experience.

The group tracker 220 supplies group tracking data 242 to the interest predictor 222. The group tracking data 242 may include information about the formation, composition, or activities of the various groups within the virtual space. By analyzing this data, the metaverse server 202 can identify potential groups of interest based on factors such as proximity, topic relevance, or social connections.

The group tracking data 242 may include any number of different types of information to provide a comprehensive understanding of group dynamics within the virtual space. For instance, the group tracker 220 may collect data on the emotional tone of conversations using sentiment analysis techniques, the frequency and duration of interactions between group members, or the rate at which new avatars join or leave a group. The group tracker 220 may also monitor non-verbal cues, such as virtual gestures or emotes used by avatars, to gauge the overall mood and engagement level of each group. In some cases, the group tracker 220 may analyze the virtual objects or shared media that groups interact with, providing context about the activities or topics that bring avatars together.

The interest predictor 222 may utilize this rich group tracking data to refine its predictions and offer more tailored recommendations. For example, the interest predictor 222 may consider the emotional tone of a conversation when determining if it aligns with a user's current mood or preferences. The interest predictor 222 may also use data on group dynamics to identify groups that are more welcoming to new members or those engaged in activities that match the user's past behavior patterns. By incorporating this detailed group information, the interest predictor 222 may more accurately assess the potential value and relevance of each group interaction for individual users, enhancing the overall metaverse experience.

The interest predictor 222 processes the attention direction data 234, the group tracking data 242, and profile data 238 to generate an interest prediction 256. The interest prediction 256 may indicate which group or conversation may be of most interest to the user avatar 236 at any given moment. In some implementations, the interest prediction 256 may be indicative of a predicted group of interest, a predicted conversation of interest, or a predicted avatar of interest. The prediction may take into account not only the current attention direction of the avatar but also the user's profile, past behaviors, and the characteristics of the available groups. The interest predictor 222 may include one or more ML components, which may be further trained based on feedback information 260 received from the client 204. This feedback loop allows the system to refine its predictions and adjust the experience enhancements based on the user's explicit actions or preferences. For example, if a user shows interest in a group that wasn't initially predicted to be relevant, the system can update its models to improve future predictions.

The interest predictor 222 may employ sophisticated ML algorithms to analyze and correlate various data inputs, including the attention direction data 234, group tracking data 242, and profile data from the profile database 226. These algorithms may include neural networks, decision trees, or ensemble methods that can identify complex patterns and relationships within the data. The interest predictor 222 may continually update its models based on real-time data, allowing it to adapt to changing user behaviors and preferences within the metaverse environment.

In some implementations, the interest predictor 222 may utilize a multi-modal approach to generate interest predictions. This approach may combine textual analysis of conversation content, visual analysis of avatar behaviors and interactions, and temporal analysis of user engagement patterns. The interest predictor 222 may also incorporate contextual factors such as the current virtual environment (e.g., a business conference vs. a social gathering), time of day, or ongoing metaverse events to refine its predictions. By considering this diverse range of inputs, the interest predictor 222 may generate highly personalized and context-aware interest predictions.

The interest predictor 222 may also implement a scoring system to quantify the level of potential interest in different groups or conversations. This scoring system may take into account factors such as the relevance of the conversation topic to the user's interests, the user's social connections within the group, the group's current engagement level, and the user's historical interactions with similar groups or topics. The resulting interest scores may be used to rank potential groups or conversations, allowing the system to prioritize which information should be presented to the user through the experience manager 224. This scoring approach may help ensure that users are presented with the most relevant and engaging opportunities for interaction within the metaverse environment.

In some implementations, the interest predictor 222 may use a threshold to determine when to share information about a group or conversation with a user avatar. The interest predictor 222 may generate an interest score for each group or conversation based on various factors such as the avatar's attention direction, profile data, and group characteristics. If the interest score exceeds a predetermined threshold, the system may share a summary or key aspects of the group's conversation with the avatar. This threshold-based approach may help filter out less relevant information and reduce cognitive overload for users in crowded metaverse environments.

The sharing process may be designed to be progressive, revealing more details as the avatar shows increased interest. For example, initially, only keywords or a brief summary might be displayed. As the avatar moves closer to a group or maintains focus for a longer period, more comprehensive summaries or even snippets of the actual conversation may be revealed. The interest predictor 222 may dynamically adjust the threshold based on factors such as the avatar's proximity to the group, duration of focus, content relevance to the avatar's profile, and the presence of known contacts within the group.

Alternative embodiments may include a multi-threshold system, where different levels of information are shared at different threshold points. Another approach may involve a probabilistic model, where the likelihood of sharing information increases gradually with the interest score, rather than using a hard cutoff. The metaverse server 202 may also employ a user-configurable threshold, allowing individuals to set their own preferences for how much information they receive about nearby conversations. Additionally, the interest predictor 222 may use a comparative approach, sharing information about the most interesting groups relative to others in the vicinity, rather than using an absolute threshold.

Based on the interest prediction 256, the experience manager 224 generates experience enhancement data 258. The experience enhancement data 258 is designed to provide the user with relevant information or guidance related to a predicted group of interest, a predicted conversation of interest, or a predicted avatar of interest. The experience enhancement data 258 is sent to the client 204, where it can be presented to the user through the user interface 212.

The experience enhancement data 258 may be used in various ways to enhance the user's experience within the metaverse environment. In some implementations, the experience enhancement data 258 may include visual cues or overlays that are displayed through the user interface 212 of the client 204. For example, the metaverse server 202 may highlight or outline the avatars in a group of interest, making them more visually prominent to the user. This visual enhancement may help guide the user's attention to potentially relevant conversations or interactions. Additionally, the metaverse server 202 may display floating text bubbles or icons above groups or individual avatars, providing brief summaries or keywords related to their ongoing conversations. These visual indicators may allow users to quickly scan their surroundings and identify discussions that align with their interests without having to approach each group individually.

In some cases, the experience enhancement data 258 may include audio enhancements to improve the user's ability to focus on relevant conversations. The metaverse server 202 may implement selective audio filtering, amplifying the audio from conversations of interest while reducing background noise from less relevant groups. This audio enhancement may be particularly useful in crowded virtual environments where multiple conversations are occurring simultaneously. The metaverse server 202 may also provide spatial audio cues, subtly adjusting the perceived direction or volume of conversations based on their relevance to the user. For instance, a highly relevant conversation may sound slightly louder or more distinct, even if it's not the closest group to the user's avatar. These audio enhancements may help users navigate complex social environments more efficiently, allowing them to focus on the most pertinent discussions.

The experience enhancement data 258 may also include interactive elements that allow users to engage more deeply with conversations of interest. For example, the metaverse server 202 may provide a discreet menu or gesture-based interface that allows users to request more information about a particular group or conversation. Upon activation, this interface may display a more detailed summary of the conversation, background information on the participants, or relevant contextual data drawn from the user's profile. In some implementations, the metaverse server 202 may offer real-time translation services as part of the experience enhancement, allowing users to engage with conversations in languages they don't speak fluently. The translation may be presented as subtitles, audio dubbing, or even as text bubbles appearing above the speaking avatars. This feature may greatly enhance regionalcross-regional communication and expand the range of interactions available to users within the metaverse environment.

By selectively sharing relevant parts of conversations, some implementations may reduce information overload and help users navigate crowded virtual environments more efficiently. The use of ML and real-time data analysis may allow for highly personalized and context-aware experience enhancements, improving the overall quality of user interactions in the metaverse. In some implementations, the ability to provide translations and regional context information facilitates cross-regional communication, making the metaverse more accessible and inclusive for a global user base. Additionally, the progressive revelation of conversation details as users show more interest allows for a natural and non-intrusive way of joining group discussions, mimicking real-world social dynamics in a virtual setting.

By tracking user interactions and updating profiles in real-time, some implementations can continually improve predictions and adapt to changing user interests and behaviors. This not only enhances the individual user experience but also provides valuable insights for metaverse operators and developers, enabling them to create more engaging and user-friendly virtual environments.

In some implementations, the metaverse server 202 may incorporate additional data sources to further refine its predictions. For example, some implementations may analyze the emotional content of conversations using natural language processing techniques, or use biometric data from VR devices to gauge user engagement levels. The experience enhancement features could also be extended to include more immersive elements, such as spatially-aware audio cues or haptic feedback, to guide users towards interesting conversations in a more intuitive manner

As indicated above, FIGS. 2A and 2B are provided as an example. Other examples may differ from what is described with regard to FIGS. 2A and 2B. The number and arrangement of devices shown in FIGS. 2A and 2B are provided as an example. A network, formed by the devices shown in FIGS. 2A and 2B may be part of a network that comprises various configurations and uses various protocols including local Ethernet networks, private networks using communication protocols proprietary to one or more companies, cellular and wireless networks (e.g., Wi-Fi), instant messaging, Hypertext Transfer Protocol (HTTP) and simple mail transfer protocol (SMTP), and various combinations of the foregoing.

There may be additional devices (e.g., a large number of devices), fewer devices, different devices, or differently arranged devices than those shown in FIGS. 2A and 2B. Furthermore, two or more devices shown in FIGS. 2A and 2B may be implemented within a single device, or a single device shown in FIGS. 2A and 2B may be implemented as multiple, distributed devices. Additionally, or alternatively, a set of devices (e.g., one or more devices) shown in FIGS. 2A and 2B may perform one or more functions described as being performed by another set of devices shown in FIGS. 2A and 2B.

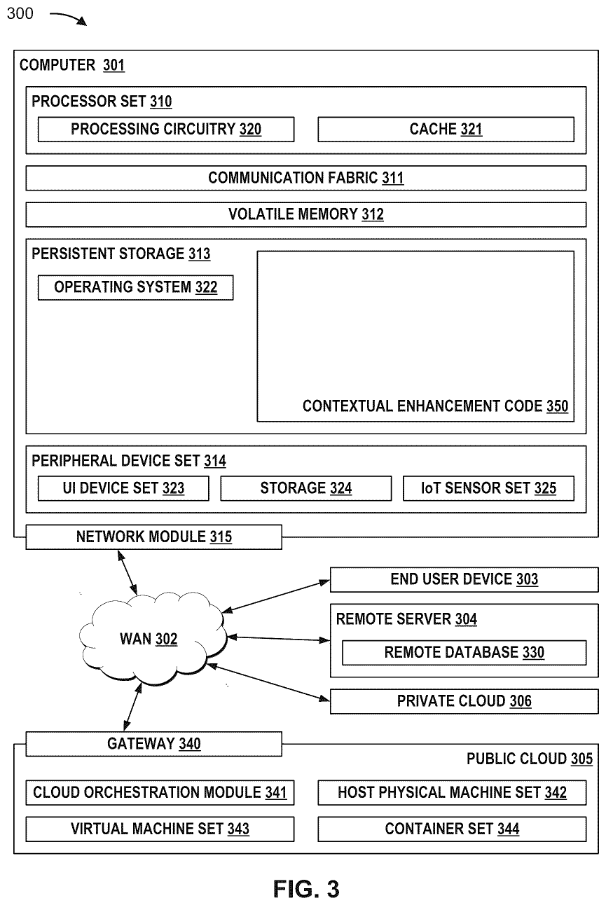

FIG. 3 is a diagram of an example computing environment 300 in which systems and/or methods described herein may be implemented. Various aspects of the present disclosure are described by narrative text, flowcharts, block diagrams of computer systems and/or block diagrams of the machine logic included in computer program product embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment is a term used in the present disclosure to describe any set of one, or more, storage media (also called “mediums”) collectively included in a set of one, or more, storage devices that collectively include machine readable code corresponding to instructions and/or data for performing computer operations specified in a given claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 300 contains an example of an environment for the execution of at least some of the computer code involved in performing the inventive methods, such as contextual enhancement code, included in block 350. Additionally, computing environment 300 includes, for example, computer 301, wide area network (WAN) 302, end user device (EUD) 303, remote server 304, public cloud 305, and private cloud 306. In this embodiment, computer 301 includes processor set 310 (including processing circuitry 320 and cache 321), communication fabric 311, volatile memory 312, persistent storage 313 (including operating system 322 and block 350, as identified above), peripheral device set 314 (including user interface (UI) device set 323, storage 324, and Internet of Things (IoT) sensor set 325), and network module 315. Remote server 304 includes remote database 330. Public cloud 305 includes gateway 340, cloud orchestration module 341, host physical machine set 342, virtual machine set 343, and container set 344.

COMPUTER 301 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 330. As is well understood in the art of computer technology, and depending upon the technology, performance of a computer-implemented method may be distributed among multiple computers and/or between multiple locations. On the other hand, in this presentation of computing environment 300, detailed discussion is focused on a single computer, specifically computer 301, to keep the presentation as simple as possible. Computer 301 may be located in a cloud, even though it is not shown in a cloud in FIG. 3. On the other hand, computer 301 is not required to be in a cloud except to any extent as may be affirmatively indicated.

PROCESSOR SET 310 includes one, or more, computer processors of any type now known or to be developed in the future. Processing circuitry 320 may be distributed over multiple packages, for example, multiple, coordinated integrated circuit chips. Processing circuitry 320 may implement multiple processor threads and/or multiple processor cores. Cache 321 is memory that is located in the processor chip package(s) and is typically used for data or code that should be available for rapid access by the threads or cores running on processor set 310. Cache memories are typically organized into multiple levels depending upon relative proximity to the processing circuitry. Alternatively, some, or all, of the cache for the processor set may be located “off chip.” In some computing environments, processor set 310 may be designed for working with qubits and performing quantum computing.

Computer readable program instructions are typically loaded onto computer 301 to cause a series of operational steps to be performed by processor set 310 of computer 301 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 321 and the other storage media discussed below. The program instructions, and associated data, are accessed by processor set 310 to control and direct performance of the inventive methods. In computing environment 300, at least some of the instructions for performing the inventive methods may be stored in block 350 in persistent storage 313.

COMMUNICATION FABRIC 311 is the signal conduction path that allows the various components of computer 301 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 312 is any type of volatile memory now known or to be developed in the future. Examples include dynamic type random access memory (RAM) or static type RAM. Typically, volatile memory 312 is characterized by random access, but this is not required unless affirmatively indicated. In computer 301, the volatile memory 312 is located in a single package and is internal to computer 301, but, alternatively or additionally, the volatile memory may be distributed over multiple packages and/or located externally with respect to computer 301.

PERSISTENT STORAGE 313 is any form of non-volatile storage for computers that is now known or to be developed in the future. The non-volatility of this storage means that the stored data is maintained regardless of whether power is being supplied to computer 301 and/or directly to persistent storage 313. Persistent storage 313 may be a read only memory (ROM), but typically at least a portion of the persistent storage allows writing of data, deletion of data and re-writing of data. Some familiar forms of persistent storage include magnetic disks and solid state storage devices. Operating system 322 may take several forms, such as various known proprietary operating systems or open source Portable Operating System Interface-type operating systems that employ a kernel. The code included in block 350 typically includes at least some of the computer code involved in performing the inventive methods.

PERIPHERAL DEVICE SET 314 includes the set of peripheral devices of computer 301. Data communication connections between the peripheral devices and the other components of computer 301 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 323 may include components such as a display screen, speaker, microphone, wearable devices (such as goggles and smart watches), keyboard, mouse, printer, touchpad, game controllers, and haptic devices. Storage 324 is external storage, such as an external hard drive, or insertable storage, such as an SD card. Storage 324 may be persistent and/or volatile. In some embodiments, storage 324 may take the form of a quantum computing storage device for storing data in the form of qubits. In embodiments where computer 301 is required to have a large amount of storage (for example, where computer 301 locally stores and manages a large database) then this storage may be provided by peripheral storage devices designed for storing very large amounts of data, such as a storage area network (SAN) that is shared by multiple, geographically distributed computers. IoT sensor set 325 is made up of sensors that can be used in Internet of Things applications. For example, one sensor may be a thermometer and another sensor may be a motion detector.

NETWORK MODULE 315 is the collection of computer software, hardware, and firmware that allows computer 301 to communicate with other computers through WAN 302. Network module 315 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 315 are performed on the same physical hardware device. In other embodiments (for example, embodiments that utilize software-defined networking (SDN)), the control functions and the forwarding functions of network module 315 are performed on physically separate devices, such that the control functions manage several different network hardware devices. Computer readable program instructions for performing the inventive methods can typically be downloaded to computer 301 from an external computer or external storage device through a network adapter card or network interface included in network module 315.

WAN 302 is any wide area network (for example, the internet) capable of communicating computer data over non-local distances by any technology for communicating computer data, now known or to be developed in the future. In some embodiments, the WAN 302 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 303 is any computer system that is used and controlled by an end user (for example, a customer of an enterprise that operates computer 301) and may take any of the forms discussed above in connection with computer 301. EUD 303 typically receives helpful and useful data from the operations of computer 301. For example, in a hypothetical case where computer 301 is designed to provide a recommendation to an end user, this recommendation would typically be communicated from network module 315 of computer 301 through WAN 302 to EUD 303. In this way, EUD 303 can display, or otherwise present, the recommendation to an end user. In some embodiments, EUD 303 may be a client device, such as thin client, heavy client, mainframe computer, desktop computer and so on.

REMOTE SERVER 304 is any computer system that serves at least some data and/or functionality to computer 301. Remote server 304 may be controlled and used by the same entity that operates computer 301. Remote server 304 represents the machine(s) that collect and store helpful and useful data for use by other computers, such as computer 301. For example, in a hypothetical case where computer 301 is designed and programmed to provide a recommendation based on historical data, then this historical data may be provided to computer 301 from remote database 330 of remote server 304.

PUBLIC CLOUD 305 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 305 is performed by the computer hardware and/or software of cloud orchestration module 341. The computing resources provided by public cloud 305 are typically implemented by virtual computing environments that run on various computers making up the computers of host physical machine set 342, which is the universe of physical computers in and/or available to public cloud 305. The virtual computing environments (VCEs) typically take the form of virtual machines from virtual machine set 343 and/or containers from container set 344. It is understood that these VCEs may be stored as images and may be transferred among and between the various physical machine hosts, either as images or after instantiation of the VCE. Cloud orchestration module 341 manages the transfer and storage of images, deploys new instantiations of VCEs and manages active instantiations of VCE deployments. Gateway 340 is the collection of computer software, hardware, and firmware that allows public cloud 305 to communicate through WAN 302.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 306 is similar to public cloud 305, except that the computing resources are only available for use by a single enterprise. While private cloud 306 is depicted as being in communication with WAN 302, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 305 and private cloud 306 are both part of a larger hybrid cloud.

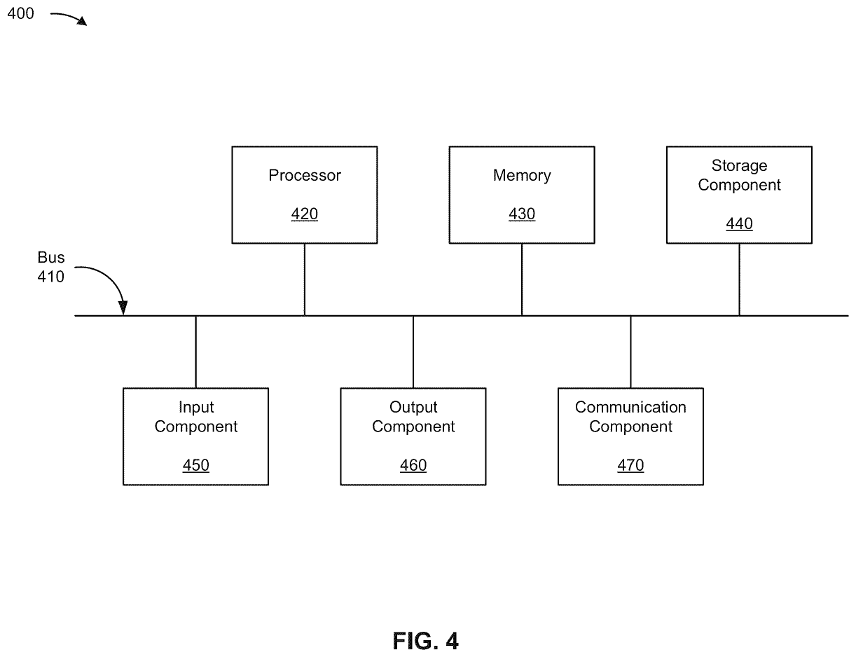

FIG. 4 is a diagram of example components of a device 400, which may correspond to the metaverse platform 102 and/or a client 104. In some implementations, the metaverse platform 102 and/or a client 104 may include one or more computing environments 300 and/or one or more components of device 400. As shown in FIG. 4, device 400 may include a bus 410, a processor 420, a memory 430, a storage component 440, an input component 450, an output component 460, and a communication component 470.

Bus 410 includes a component that enables wired and/or wireless communication among the components of device 400. Processor 420 includes a central processing unit, a graphics processing unit, a microprocessor, a controller, a microcontroller, a digital signal processor, a field-programmable gate array, an application-specific integrated circuit, and/or another type of processing component. Processor 420 is implemented in hardware, firmware, or a combination of hardware and software. In some implementations, processor 420 includes one or more processors capable of being programmed to perform a function. Memory 430 includes a random access memory, a read only memory, and/or another type of memory (e.g., a flash memory, a magnetic memory, and/or an optical memory).

Storage component 440 stores information and/or software related to the operation of device 400. For example, storage component 440 may include a hard disk drive, a magnetic disk drive, an optical disk drive, a solid state disk drive, a compact disc, a digital versatile disc, and/or another type of non-transitory computer-readable medium. Input component 450 enables device 400 to receive input, such as user input and/or sensed inputs. For example, input component 450 may include a touch screen, a keyboard, a keypad, a mouse, a button, a microphone, a switch, a sensor, a global positioning system component, an accelerometer, a gyroscope, and/or an actuator. Output component 460 enables device 400 to provide output, such as via a display, a speaker, and/or one or more light-emitting diodes. Communication component 470 enables device 400 to communicate with other devices, such as via a wired connection and/or a wireless connection. For example, communication component 470 may include a receiver, a transmitter, a transceiver, a modem, a network interface card, and/or an antenna.

Device 400 may perform one or more processes described herein. For example, a non-transitory computer-readable medium (e.g., memory 430 and/or storage component 440) may store a set of instructions (e.g., one or more instructions, code, software code, and/or program code) for execution by processor 420. Processor 420 may execute the set of instructions to perform one or more processes described herein. In some implementations, execution of the set of instructions, by one or more processors 420, causes the one or more processors 420 and/or the device 400 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 4 are provided as an example. Device 400 may include additional components, fewer components, different components, or differently arranged components than those shown in FIG. 4. Additionally, or alternatively, a set of components (e.g., one or more components) of device 400 may perform one or more functions described as being performed by another set of components of device 400.

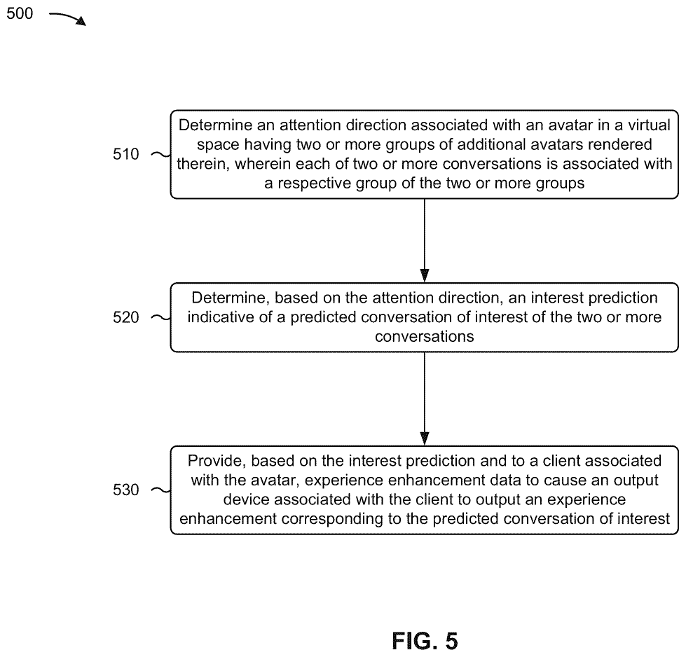

FIG. 5 is a flowchart of an example process 500 associated with facilitating communication among avatars in a metaverse environment as described herein. In some implementations, one or more process blocks of FIG. 5 may be performed by a metaverse platform (e.g., the metaverse platform 102 shown in FIG. 1) and/or a metaverse server (e.g., the metaverse server 202 shown in FIG. 2A). Additionally, or alternatively, one or more process blocks of FIG. 5 may be performed by one or more components of device 400, such as processor 420, memory 430, storage component 440, input component 450, output component 460, and/or communication component 470.

As shown in FIG. 5, the process 500 may include determining an attention direction associated with an avatar in a virtual space having two or more groups of additional avatars rendered therein, where each of two or more conversations is associated with a respective group of the two or more groups (block 510). For example, the metaverse platform may determine an attention direction associated with an avatar in a virtual space having two or more groups of additional avatars rendered therein, where each of two or more conversations is associated with a respective group of the two or more groups, as described above in connection with FIGS. 2A and 2B. In some implementations, determining the attention direction comprises determining a gaze direction of the avatar, where the attention direction is based on the gaze direction. In some implementations, determining the attention direction comprises determining a direction of movement of the avatar, where the attention direction is based on the direction of movement.

As further shown in FIG. 5, the process 500 may include determining, based on the attention direction, an interest prediction indicative of a predicted group of interest of the two or more groups (block 520). For example, the metaverse platform may determine, based on the attention direction, an interest prediction indicative of a predicted group of interest of the two or more groups, as described above in connection with FIGS. 2A and 2B. In some implementations, determining the interest prediction comprises obtaining profile data associated with at least one of the avatar or a user associated with the avatar; and determining the interest prediction based on the attention direction and the profile data. For example, in some implementations, determining the interest prediction includes determining the interest prediction based on a machine learning component that takes, as input, the attention direction and the profile data.

As further shown in FIG. 5, the process 500 may include providing, based on the interest prediction and to a client associated with the avatar, experience enhancement data to cause an output device associated with the client to output an experience enhancement corresponding to a conversation associated with the predicted group of interest (block 530). For example, the metaverse platform may provide, based on the interest prediction and to a client associated with the avatar, experience enhancement data to cause an output device associated with the client to output an experience enhancement corresponding to a conversation associated with the predicted group of interest.

In some implementations, the process 500 includes generating the experience enhancement data based on the interest prediction, where the experience enhancement data comprises a summary of the conversation of the predicted group of interest. In some implementations, the process 500 includes generating the experience enhancement data based on the interest prediction, where the experience enhancement data comprises a keyword of the conversation of the predicted group of interest.

In some implementations, the process 500 includes obtaining conversation data associated with the conversation of the predicted group of interest; determining that a first language associated with the avatar is different than a second language corresponding to the conversation data; and generating, based on the conversation data, a translation of at least a portion of the conversation of the predicted group of interest, where the experience enhancement data comprises the translation. In some implementations, the process 500 includes determining a first regional profile based on a profile associated with the avatar; obtaining gesture data associated with a gesture performed by an additional avatar of the predicted group of interest; determining a second regional profile based on at least one of a profile associated with the additional avatar or a set of contextual data associated with the conversation of the predicted group of interest; and generating, based on a difference between the first regional profile and the second regional profile, contextual gesture information associated with the gesture, where the experience enhancement data comprises the contextual gesture information.

In some implementations, the process 500 includes detecting a movement of the avatar towards the predicted group of interest and providing, based on the movement and to the client, additional experience enhancement data to cause the output device to output an additional experience enhancement corresponding to the predicted group of interest. In some implementations, the process 500 includes obtaining, from the client, a user input comprising an indication of disinterest in the conversation associated with the predicted group of interest; determining, based on the user input, an additional interest prediction associated with an additional predicted group of interest; and providing, based on the additional interest prediction, additional experience enhancement data to cause the output device to output an additional experience enhancement corresponding to the additional predicted group of interest. In some implementations, the process 500 includes obtaining avatar tracking information associated with at least one of the attention direction, a movement of the avatar, or a participation of the avatar in the conversation associated with the predicted group of interest; and providing the avatar tracking information to a profile engine to cause the profile engine to update a profile associated with the avatar based on the avatar tracking information.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A computer system comprising:
a processor set;
one or more computer-readable storage media; and
program instructions stored on the one or more computer-readable storage media to cause the processor set to perform operations comprising:
determining an attention direction associated with an avatar in a virtual space having two or more groups of additional avatars rendered therein, wherein each of two or more conversations is associated with a respective group of the two or more groups;
determining, based on the attention direction, an interest prediction indicative of a predicted group of interest of the two or more groups; and
providing, based on the interest prediction and to a client associated with the avatar, experience enhancement data to cause an output device associated with the client to output an experience enhancement corresponding to a conversation associated with the predicted group of interest.

2. The computer system of claim 1, wherein determining the attention direction comprises:
determining a gaze direction of the avatar, wherein the attention direction is based on the gaze direction.

3. The computer system of claim 1, wherein determining the attention direction comprises:
determining a direction of movement of the avatar, wherein the attention direction is based on the direction of movement.

4. The computer system of claim 1, wherein determining the interest prediction comprises:
obtaining profile data associated with at least one of the avatar or a user associated with the avatar; and
determining the interest prediction using a machine learning component that takes, as input, the attention direction and the profile data.

5. The computer system of claim 1, the operations further comprising:
generating the experience enhancement data based on the interest prediction, wherein the experience enhancement data comprises a summary of the conversation of the predicted group of interest.

6. The computer system of claim 1, the operations further comprising:
generating the experience enhancement data based on the interest prediction, wherein the experience enhancement data comprises a keyword of the conversation of the predicted group of interest.

7. The computer system of claim 1, the operations further comprising:
obtaining conversation data associated with the conversation of the predicted group of interest;
determining that a first language associated with the avatar is different than a second language corresponding to the conversation data; and
generating, based on the conversation data, a translation of at least a portion of the conversation of the predicted group of interest, wherein the experience enhancement data comprises the translation.

8. The computer system of claim 1, the operations further comprising:
determining a first regional profile based on a profile associated with the avatar;
obtaining gesture data associated with a gesture performed by an additional avatar of the predicted group of interest;
determining a second regional profile based on at least one of a profile associated with the additional avatar or a set of contextual data associated with the conversation of the predicted group of interest; and
generating, based on a difference between the first regional profile and the second regional profile, contextual gesture information associated with the gesture, wherein the experience enhancement data comprises the contextual gesture information.

9. The computer system of claim 1, the operations further comprising:
detecting a movement of the avatar towards the predicted group of interest; and
providing, based on the movement and to the client, additional experience enhancement data to cause the output device to output an additional experience enhancement corresponding to the predicted group of interest.

10. The computer system of claim 1, the operations further comprising:
obtaining, from the client, a user input comprising an indication of disinterest in the conversation associated with the predicted group of interest;
determining, based on the user input, an additional interest prediction associated with an additional predicted group of interest; and
providing, based on the additional interest prediction, additional experience enhancement data to cause the output device to output an additional experience enhancement corresponding to the additional predicted group of interest.

11. The computer system of claim 1, the operations further comprising:
obtaining avatar tracking information associated with at least one of the attention direction, a movement of the avatar, or a participation of the avatar in the conversation associated with the predicted group of interest; and
providing the avatar tracking information to a profile engine to cause the profile engine to update a profile associated with the avatar based on the avatar tracking information.

12. A computer-implemented method comprising:
determining an attention direction associated with an avatar in a virtual space having two or more groups of additional avatars rendered therein, wherein each of two or more conversations is associated with a respective group of the two or more groups;
determining, based on the attention direction, an interest prediction indicative of a predicted conversation of interest of the two or more conversations; and
providing, based on the interest prediction and to a client associated with the avatar, experience enhancement data to cause an output device associated with the client to output an experience enhancement corresponding to the predicted conversation of interest.

13. The method of claim 12, wherein determining the attention direction comprises:
determining a gaze direction of the avatar, wherein the attention direction is based on the gaze direction.

14. The method of claim 12, wherein determining the attention direction comprises:
determining a direction of movement of the avatar, wherein the attention direction is based on the direction of movement.

15. The method of claim 12, wherein determining the interest prediction comprises:
obtaining profile data associated with at least one of the avatar or a user associated with the avatar; and
determining the interest prediction based on the attention direction and the profile data.

16. The method of claim 12, further comprising:
generating the experience enhancement data based on the interest prediction, wherein the experience enhancement data comprises at least one of a summary of the conversation of interest or a keyword of the conversation of interest.

17. A computer program product comprising:
one or more computer-readable storage media; and
program instructions stored on the one or more computer-readable storage media to perform operations comprising:
determining an attention direction associated with an avatar in a virtual space having two or more groups of additional avatars rendered therein;
determining, based on the attention direction, an interest prediction indicative of a predicted group of interest of the two or more groups of additional avatars; and
providing, based on the interest prediction and to a client associated with the avatar, experience enhancement data to cause an output device associated with the client to output an experience enhancement corresponding to the predicted group of interest.

18. The computer program product of claim 17, the operations further comprising:
obtaining conversation data associated with a conversation of the predicted group of interest;
determining that a first language associated with the avatar is different than a second language corresponding to the conversation data; and
generating, based on the conversation data, a translation of at least a portion of the conversation of the predicted group of interest, wherein the experience enhancement data comprises the translation.

19. The computer program product of claim 17, the operations further comprising:
determining a first regional profile based on a profile associated with the avatar;
obtaining gesture data associated with a gesture performed by an additional avatar of the predicted group of interest;
determining a second regional profile based on at least one of a profile associated with the additional avatar or a set of contextual data associated with a conversation of the predicted group of interest; and
generating, based on a difference between the first regional profile and the second regional profile, contextual gesture information associated with the gesture, wherein the experience enhancement data comprises the contextual gesture information.

20. The computer program product of claim 17, the operations further comprising:
detecting a movement of the avatar towards the predicted group of interest; and
providing, based on the movement and to the client, additional experience enhancement data to cause the output device to output an additional experience enhancement corresponding to the predicted group of interest.
